(19) United States
(12) Patent Application Publication
(10) Pub. No.: US 2018/0165965 A1
(43) Pub. Date: Jun. 14, 2018

(54) METHOD AND DEVICE FOR DETECTING AT LEAST ONE PEDESTRIAN BY A VEHICLE

(71) Applicant: Robert Bosch GmbH, Stuttgart (DE)

(72) Inventors: Marlon Ramon Ewert, Untergruppenbach (DE); Nikolaos Gortsas, Sindelfingen (DE)

(21) Appl. No.: 15/825,258

(22) Filed: Nov. 29, 2017

(30) Foreign Application Priority Data
Dec. 8, 2016 (DE) 102016224516.3

(51) Int. Cl. G08G 1/16; G08G 1/005; H04W 4/04; G01S 5/00; G08G 1/0967; H04W 84/12

(52) U.S. Cl. CPC G08G 1/166; G08G 1/005; H04W 84/12; G01S 5/0072; G08G 1/096783; H04W 4/046

(57) ABSTRACT

A method for detecting at least one pedestrian by a vehicle. The method includes at least one step of reading in and one step of processing. In the step of reading in, at least one pedestrian signal provided or output by a unit situated externally to the vehicle is read in, the signal representing a pedestrian situated in a pedestrian position. In the step of processing, the pedestrian signal is processed to provide a signal for detecting the pedestrian.

### CROSS REFERENCE

The present application claims the benefit under 35 U.S.C. § 119 of German Patent Application No. DE 102016224516.3 filed on Dec. 8, 2016, which is expressly incorporated herein by reference in its entirety.

### BACKGROUND INFORMATION

Some vehicles are equipped with a vehicle-internal surroundings sensor system for detecting pedestrians, which detects pedestrians with the aid of radar and/or camera systems and/or LIDAR systems and/or distance sensors.

The present invention is directed to a device, a method, and a computer program.

### SUMMARY

In accordance with the present invention, a method is provided for detecting at least one pedestrian by a vehicle, furthermore a device which uses this method, and finally a corresponding computer program. Advantageous refinements of and improvements on the device are described herein.

Advantages of the present invention include that pedestrians are also detected without a surroundings sensor system situated in the vehicle for detecting pedestrians. In this way, pedestrians not perceptible or visible from the vehicle may nonetheless be detected by the vehicle or a driver of the vehicle.

A method for detecting at least one pedestrian by a vehicle is provided. The method includes at least one step of reading in and one step of processing. In the step of reading in, at least one pedestrian signal provided or output by a unit situated externally to the vehicle is read in, the signal representing a pedestrian situated in a pedestrian position. In the step of processing, the pedestrian signal is processed to provide a signal for detecting the pedestrian. As a result of the externally situated unit reading in the pedestrian signal, highly precise pedestrian positions, which, for example, were read in or provided by the external unit itself, such as a cell phone, may advantageously be utilized quickly and easily.

It is advantageous when, in the step of processing, a distance between the pedestrian position and a position of the vehicle is calculated. In this way, the signal may be output or provided, for example, as a function of the calculated distance, which may indicate how imminent a collision risk between the vehicle and the pedestrian is. When the method according to one advantageous specific embodiment includes a step of outputting, in which the signal is output when the distance drops below a minimum distance, this may indicate a pedestrian who, for example, is situated dangerously close to the vehicle, but not directly visible. In this way, it is possible to detect a pedestrian situated behind a corner or curve, for example. The minimum distance may represent a distance of 100 meters, for example.

In the step of reading in, the pedestrian signal may be read in by the unit configured as an infrastructure unit. The infrastructure unit may be designed, for example, to read in a wide variety of surroundings signals and then provide these for vehicles, allowing a plurality of instantaneous surroundings signals to be accessed via a car-to-infrastructure communication.

In addition or as an alternative, in the step of reading in, the pedestrian signal may be read in by the unit configured as a mobile unit, which is situated on the pedestrian. In the step of reading in, the pedestrian signal may be read in by the unit with the aid of radio transmission and/or radio position finding, such as NFC, and/or WLAN and/or mobile communication and/or Internet and/or a satellite positioning system, such as GPS and/or GLONASS and/or BeiDou and/or Galileo. Read-in radio signals and/or position data may enable an exact geographical locating of the pedestrian. For example, in the step of reading in, the pedestrian signal may also be read in by an integrated circuit, such as an NFC chip, of the mobile unit configured as a cell phone and/or a piece of clothing of the pedestrian. Since cell phones and frequently also modern clothing include such NFC chips, this may offer a simple and reliable option for detecting the associated pedestrians.

It is furthermore advantageous when, in the step of outputting, the signal is output which is designed to change a trajectory and/or a speed of the vehicle. If, for example, it is established in the step of processing that the upcoming trajectories between the pedestrian and the vehicle will overlap or could overlap, a triggered reduction of the speed and/or a full deceleration and/or an initiated evasive maneuver of the vehicle may prevent a collision between the pedestrian and the vehicle.

When the vehicle is operated manually or semi-automatedly by the driver, it is advantageous when, in the step of outputting, the signal is output which is designed to indicate at least the pedestrian position on a display unit in the vehicle, in particular on a field of view display device, such as a head-up display. This offers the driver the option of driving anticipatorily and/or actively intervening in an impending traffic situation.

This method may be implemented in software or hardware or in a mixed form made up of software and hardware, for example in a control unit.

The approach described here furthermore creates a device which is designed to carry out, activate or implement the steps of one variant of a method described here in corresponding devices. The object underlying the approach may also be achieved quickly and efficiently by this embodiment variant of the approach in the form of a device.

For this purpose, the device may include at least one processing unit for processing signals or data, at least one memory unit for storing signals or data, at least one interface to a sensor or an actuator for reading in sensor signals from the sensor or for outputting data signals or control signals to the actuator and/or at least one communication interface for reading in or outputting data which are embedded into a communication protocol. The processing unit may be a signal processor, a microcontroller or the like, for example, it being possible for the memory unit to be a Flash memory, an EPROM or a magnetic memory unit. The communication interface may be designed to read in or output data wirelessly and/or in a wire-bound manner, a communication interface which is able to read in or output wire-bound data being able to read these data in, for example electrically or optically, from a corresponding data transmission line or output these into a corresponding data transmission line.

A device may presently be understood to mean an electrical device which processes sensor signals and outputs control and/or data signals as a function thereof. The device may include an interface which may be designed as hardware and/or software. In the case of a hardware design, the interfaces may, for example, be part of a so-called system ASIC which includes a wide variety of functions of the device. However, it is also possible for the interfaces to be separate integrated circuits, or to be at least partially made up of discrete elements. In the case of a software design, the interfaces may be software modules which are present on a microcontroller, for example, in addition to other software modules.

In one advantageous embodiment, the device carries out a control of a signal for detecting a pedestrian. For this purpose, the device may access sensor signals, for example, such as at least one pedestrian signal. The activation takes place at least via actuators, such as a read-in unit, a processing unit and an output unit.

In addition, a computer program product or computer program is advantageous, having program code which may be stored on a machine-readable carrier or storage medium such as a semiconductor memory, a hard disk memory or an optical memory, and which is used to carry out, implement and/or activate the steps of the method according to one of the specific embodiments described above, in particular if the program product or program is executed on a computer or a device.

Exemplary embodiments of the approach described here are shown in the figures and are described in greater detail below.

### BRIEF DESCRIPTION OF THE DRAWINGS

FIG. 1 shows a schematic top view onto a vehicle including a device for detecting at least one pedestrian according to one exemplary embodiment.

FIG. 2 shows a schematic representation of a device for detecting at least one pedestrian according to one exemplary embodiment.

FIG. 3 shows a schematic top view onto a vehicle including a device for detecting at least one pedestrian according to one exemplary embodiment.

FIG. 4 shows a schematic top view onto a collision between a conventional vehicle and a pedestrian.

FIG. 5 shows a flow chart of a method for detecting a pedestrian according to one exemplary embodiment.

### DETAILED DESCRIPTION OF EXAMPLE EMBODIMENTS

In the description below of favorable exemplary embodiments of the present approach, identical or similar reference numerals are used for similarly acting elements shown in the different figures, and a repeated description of these elements is dispensed with.

FIG. 1 shows a schematic top view onto a vehicle 100 including a device 105 for detecting at least one pedestrian 110 according to one exemplary embodiment.

According to this exemplary embodiment, vehicle 100 is driving on a road 112 and situated in front of an intersection 114 of road 112 with a cross street 115. Pedestrian 110 is situated on cross street 115 extending transversely to road 112 and, due to a building 120 blocking a view, is both not visible from vehicle 100 and not perceptible by a vehicle-internal surroundings sensor system of vehicle 100.

According to this exemplary embodiment, described device 105 is accommodated in vehicle 100 and reads in a pedestrian signal 125, which represents pedestrian 110 situated in a pedestrian position. Device 105 is furthermore designed to process pedestrian signal 125 to provide a signal for detecting pedestrian 110.

According to this exemplary embodiment, device 105 reads in pedestrian signal 125 with the aid of radio transmission from a cell phone 130 of pedestrian 110.

Previously described details of device 105 are described again hereafter in greater detail.

Device 105 described here may also be referred to as a device for locating pedestrians 110 via radio interfaces in a vehicle 100 for collision prediction and collision avoidance.

Car-to-car communication, Car2Car or C2C in short, is understood to mean an exchange of pieces of information and data between motor vehicles. The goal of this data exchange is to notify drivers of vehicles 100 of critical and dangerous situations at an early stage. The particular vehicles 100 collect data, such as ABS interventions, steering angle, position, direction and speed, and transmit these data via radio, such as WLAN and/or UMTS, to other road users, i.e., other vehicles. A range of vision of the driver is to be extended by electronic means. Car-to-infrastructure communication, C2I in short, is understood to mean an exchange of data between a vehicle 100 and a surrounding infrastructure, e.g., traffic lights. The aforementioned technologies are based on a cooperation of sensors of the different traffic partners and use latest methods of communication technology for exchanging these pieces of information.

A vehicle drivable in a highly automated manner is a vehicle that does not require a driver. The vehicle drives in a highly automated manner, for example, by automatically detecting a course of the road, other road users or obstacles and calculating appropriate control commands in the vehicle, and forwarding these to actuators in the vehicle, whereby a driving course of the vehicle is correctly influenced. The driver himself or herself is not involved in the driving process in the case of a vehicle drivable in a fully highly automated manner. Presently available vehicles are not yet able to operate in a highly automated or autonomous manner; on the one hand because the corresponding technology has not matured yet, and on the other hand because it is required by law today that a vehicle driver must be able to intervene personally in the driving process at all times. This makes the implementation of vehicles drivable in a fully highly automated manner more difficult. However, there are already systems from different manufacturers which represent highly automated or semi-automated driving. These systems are presently undergoing the intensive test phase. Even today, it is foreseeable that fully automated or fully autonomous vehicle systems will enter the market in a few years, as soon as the above-mentioned hurdles are overcome.

At present, a vehicle distance between a host vehicle and another vehicle is already ascertained in series-production vehicles with the aid of distance sensors and is set in such a way that a collision with the other preceding vehicle is avoided. A minimum distance is ascertained by a measured distance between the vehicles and their relative speed with respect to one another. This driver assistance system intervenes in the traffic situation, if necessary, as soon as there is a drop below a calculated minimum distance and, if necessary, carries out an emergency braking. In this way, rear-end collisions are avoided, for example. To determine the vehicle distance with respect to other road users, distance sensors, such as radar systems, are used today.

In contrast to conventional radar systems or camera systems or LIDAR systems, device 105 described here is advantageously not prone to errors, for example due to distorted reflections of radar waves on metallic objects, i.e., calculations of the distances are correct thanks to device 105, and the distances are exactly determinable. Another advantage is additionally that device 105 is also able to exactly determine distances to other road users if the view includes a lot of obstacles. This means that, in intersection scenarios such as intersection 114 shown here, additional road users, such as pedestrian 110, are already detected by device 105 of vehicle 100 prior to entering intersection 114, which may avoid an accident. It is not possible to initiate an evasive maneuver in a timely manner without device 105 if a pedestrian 110 suddenly steps into the driving process since pedestrian 110 is detected too late or not at all by the known surroundings sensor system.

According to this exemplary embodiment, the approach described here thus makes it possible to locate the position, relative to host vehicle 100 via a radio interface, of pedestrians 110, who are situated at a minimum distance to host vehicle 100. To meet this requirement, various methods may be used, which are incorporated into the car-to-car and/or car-to-infrastructure communication interface already present in vehicle 100. Pedestrians 110 may be located as follows.

According to this exemplary embodiment, pedestrian 110 is located with the aid of radio transmission of cell phone 130 carried by pedestrian 110 on his or her body. An intensity of the radio transmission or a propagation time difference of the radio signal or the radio signals relative to host vehicle 100 is resorted to for this purpose. For precise locating, moreover a speed and a driving direction of vehicle 100 are resorted to.

According to one alternative exemplary embodiment, pedestrian 110 is, or further pedestrians are, additionally or alternatively located with the aid of radio position finding, such as via NFC (near field communication) chips, which are integrated, e.g., in cell phones 130 or in the clothing of pedestrians 110 and emit a radio signal. The intensity of the transmission or the propagation time difference of the radio signals relative to host vehicle 100 is also resorted to for this purpose. For precise locating, moreover the speed and driving direction of vehicle 100 are resorted to.

According to one further alternative exemplary embodiment, pedestrian 110 is, or further pedestrians are, additionally or alternatively located with the aid of GPS and/or GLONASS and/or BeiDou and/or Galileo position data which are emitted by cell phones 130 of pedestrians 110 directly to the surroundings or to host vehicle 100.

If pedestrians 110 were correctly detected in the surroundings, according to this exemplary embodiment a vehicle speed or a vehicle trajectory is anticipatorily adapted to the pedestrian behavior or his or her movement relative to vehicle 100. In this way, collisions that the conventional surroundings sensor system of vehicle 100 is not able to detect or avoid may be reliably predicted and avoided. A further function of device 105 is to graphically represent within vehicle 100, the detected pedestrians 110 in the field of vision, via a human machine interface (HMI), for example a field of view display device, such as a head-up display, in vehicle 100 for the vehicle driver in a position relative to vehicle 100, so that the driver in a vehicle not driving in a highly automated manner is able to respond in a timely manner. In vehicles drivable in a highly automated or semi-automated manner, in contrast, braking or evasive maneuvers are automatically carried out by vehicles 100 when a collision with a pedestrian is imminent.

In summary, the approach described here is to use a car-to-car or car-to-infrastructure communication interface available in the near future in vehicle 100 in order to locate pedestrians 110 in the more immediate vehicle surroundings, including their pedestrian positions relative to host vehicle 100, with the aid of device 105 and to make them graphically visible for the driver. Moreover, these pieces of information are coupled with anticipatory systems in vehicles 100, whereby evasive maneuvers may be anticipatorily planned and carried out, in particular when pedestrians 110 are not visible to the conventional surroundings sensor system installed in vehicle 100.

Hereafter, a critical scenario illustrated in FIG. 1 here is described again by way of example, which would not be detected, or would be detected too late, by existing distance sensors in vehicle 100 alone, and consequently without device 105 would result in an accident which, however, is avoided thanks to device 105.

FIG. 1 shows a turning process of vehicle 100 into hidden cross street 115 by way of example. Pedestrian 110, who is traversing cross street 115, is situated in cross street 115, with vehicle 100 wanting to turn into hidden cross street 115. Due to building 120, however, the conventional surroundings sensor system of vehicle 100, e.g., with the aid of radar/camera/LIDAR, is not able to detect in a timely manner that pedestrian 110 who is traversing cross street 115 is situated behind the curve. A conventional surroundings sensor system of vehicle 100 would detect pedestrian 110 in cross street 115 only after vehicle 100 enters cross street 115 at high speed, and would initiate emergency braking only then. According to this exemplary embodiment, however, a speed of vehicle 100 is decreased in a timely manner in response to pedestrian signal 125, and an accident is thus reliably avoided.

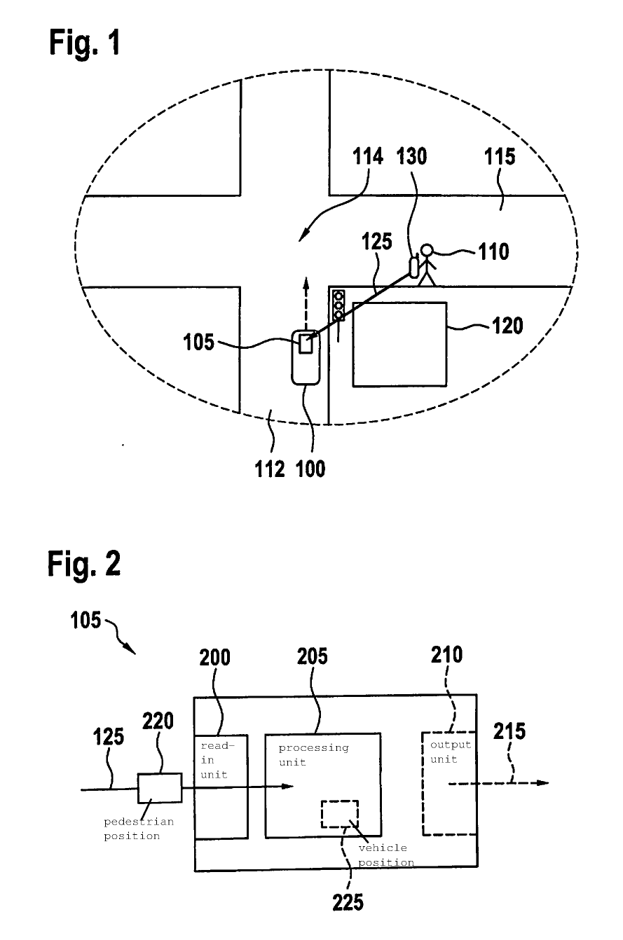

FIG. 2 shows a schematic representation of a device 105 for detecting at least one pedestrian 110 according to one exemplary embodiment. This may be device 105 described based on FIG. 1.

According to this exemplary embodiment, device 105 includes a read-in unit 200, a processing unit 205 and optionally an output unit 210. Read-in unit 200 is designed to read in pedestrian signal 125. Processing unit 205 is designed to process pedestrian signal 125 to provide signal 215 for detecting the pedestrian.

According to this exemplary embodiment, processing unit 205 is at least designed to calculate a distance between pedestrian position 220 and a vehicle position 225 of the vehicle.

According to this exemplary embodiment, output unit 210 is designed to output signal 215 when the distance drops below a minimum distance.

Previously described details of device 105 are described again hereafter in greater detail.

Device 105 described here allows critical scenarios to be avoided by exchanging vehicle parameters via a car-to-car or car-to-infrastructure communication.

Critical traffic scenarios often have in common that pedestrians are detected too late by a conventional surroundings sensor system in a vehicle. Countermeasures derived therefrom, e.g., emergency brakings, are implemented too late by the vehicle, and serious accidents occur. At this point, device 105 introduced here intervenes. The vehicles situated at the minimum distance to certain pedestrians receive radio signals and/or pedestrian positions 220 in the form of pedestrian signals 125 of the corresponding pedestrians via a car-to-car or car-to-infrastructure communication interface in the form of read-in unit 200. In the next step, processing unit 205 calculates pedestrian positions 220 relative to the vehicle inside the vehicle itself.

Possible interfaces for the exchange of radio signals and/or position data between pedestrians and vehicles are: The data exchange between pedestrians and the vehicle takes place via radio connections, such as NFC, WLAN or mobile communication. It is important here that the radio signals or pedestrian positions 220 are transmitted with a sufficiently high speed since the distance between the vehicle and the pedestrian may at times be very short.

Possible data, i.e., data read in with the aid of pedestrian signal 125, which are exchanged within the scope of the communication between the pedestrian and vehicles are: GPS and/or GLONASS and/or BeiDou and/or Galileo coordinates of the pedestrian and/or radio signals including a time stamp and/or a signal strength of the radio signals and/or parameters for a communication quality and/or pedestrian identification numbers.

The GPS and/or GLONASS and/or BeiDou and/or Galileo coordinates of the pedestrian are used to directly calculate a relative position of the pedestrian with respect to the host vehicle, the vehicle position of the host vehicle also having been determined in high quality in advance in the corresponding GPS and/or GLONASS and/or BeiDou and/or Galileo system. From the radio signal provided with a time stamp and from its strength, a pedestrian position relative to the vehicle is calculated inside the vehicle, e.g., via a radio position finding or via the propagation time of the radio signals in conjunction with the speed and the driving direction of the vehicle. Additionally, parameters for the communication quality may be exchanged, for example to detect defective radio signals in a timely manner and initiate appropriate countermeasures in the vehicle. The optional identification number of the pedestrian is derived, e.g., from the serial number of the cell phone or from the serial number of the corresponding NFC chips. Furthermore, a purely vehicle-internal assignment of pedestrian IDs for the internal calculations or for a pedestrian representation on a display device of the vehicle is conceivable. According to one alternative exemplary embodiment, pedestrians transmit their position data via their cell phone directly to the surroundings or infrastructure, e.g., anonymized. Via the car-to-infrastructure communication interface in the form of read-in unit 200, the surroundings thereupon inform the vehicle in the form of the pedestrian signals 125 as to where pedestrians are situated in the vicinity of the vehicle. This takes place as a function of the instantaneous vehicle position for pedestrians within a minimum distance to the vehicle.

Due to the early locating of pedestrians in the surroundings of the vehicle made possible by device 105, e.g., via the car-to-car communication interface in the vehicles and the cell phones or so-called intelligent clothing of the pedestrians, serious accidents may be avoided. Additionally, the trajectory planning in the vehicles driveable in a semi-automated or highly automated manner may thus be improved by signal 215. In vehicles not driveable in a highly automated manner, the surroundings of the vehicle including the located pedestrians are visibly represented for the driver by signal 215 via the HMI, e.g., a head-up display. The driver may then himself or herself reduce the vehicle speed in a timely manner or initiate evasive maneuvers.

Based on the critical scenario of a turning process into a hidden cross street including the pedestrian, as described in FIG. 1, this means in detail: Via the car-to-car or car-to-infrastructure communication interface in the form of read-in unit 200, the vehicle receives radio signals of the cell phone of the pedestrian or, according to one alternative exemplary embodiment, radio signals from the clothing of the pedestrian or position data from the cell phone of the pedestrian in the form of pedestrian signal 125 and then, in processing unit 205, in a timely manner and in real time calculates the position of the pedestrian relative to the host vehicle, even though the pedestrian is not visible to the surroundings sensor system of the vehicle. This occurs already prior to turning into the intersection. The vehicle thus establishes in a timely manner that the pedestrian is in the process of traversing the cross street, thereupon reducing its speed as a result of signal 215, and takes the turn only slowly. The vehicle comes to a standstill even before reaching the pedestrian, and the collision is avoided.

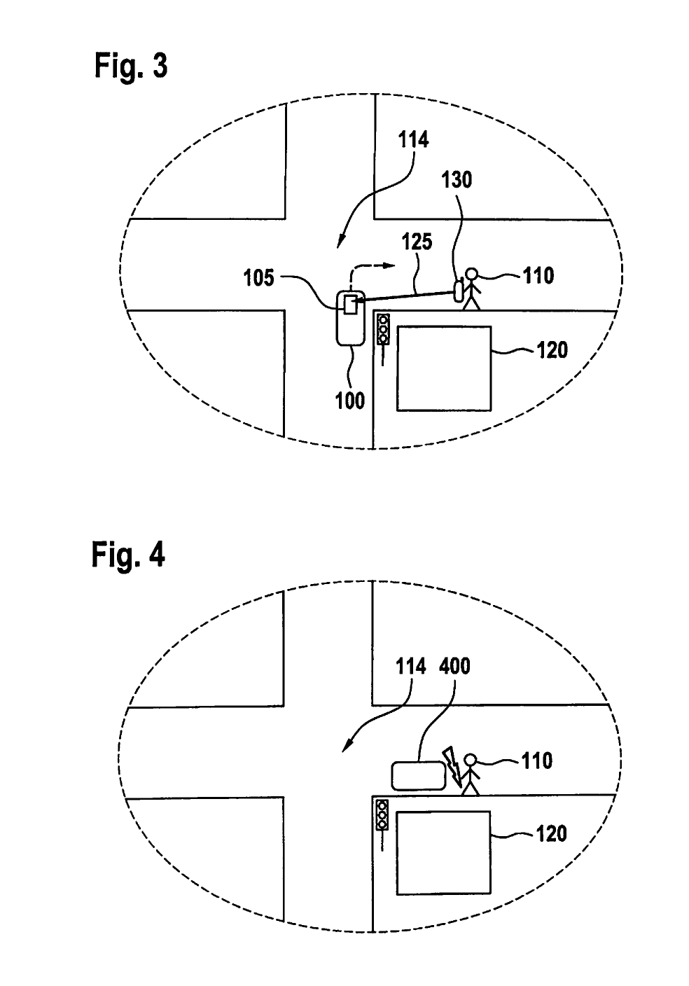

FIG. 3 shows a schematic top view onto a vehicle 100 including a device 105 for detecting at least one pedestrian according to one exemplary embodiment. This may be vehicle 100 and device 105 described based on FIG. 2. This shows a later point in time of the scenario in intersection 114 described in FIG. 1.

The now turning vehicle 100 has already detected pedestrian 110 with the aid of device 105 and has decreased a vehicle speed for entering the cross street, whereby an accident is prevented.

FIG. 4 shows a schematic top view onto a collision between a conventional vehicle 400 and a pedestrian 110.

The turning conventional vehicle 400, which does not include the device described in the preceding figures, hits pedestrian 110 since an emergency braking of vehicle 400 took place too late. Many other critical scenarios beyond this critical scenario are possible, in which a pedestrian 110 is not detected in a timely manner by the conventional surroundings sensor system of vehicle 400.

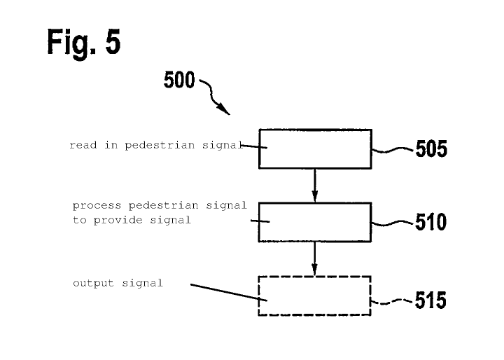

FIG. 5 shows a flow chart of a method 500 for detecting at least one pedestrian according to one exemplary embodiment. This may be a method 500 which is executable or activatable by a device described based on one of FIGS. 1 through 3.

Method 500 includes at least one step 505 of reading in and one step 510 of processing. In step 505 of reading in, at least one pedestrian signal provided or output by a unit situated externally to the vehicle is read in, which represents a pedestrian situated in a pedestrian position. In step 510 of processing, the pedestrian signal is processed to provide a signal for detecting the pedestrian.

According to this exemplary embodiment, in step 510 of processing, a distance between the pedestrian position and a vehicle position of the vehicle is calculated.

Optionally, method 500 furthermore includes a step 515 of outputting, in which the signal is output when the distance calculated in step 510 of processing drops below a minimum distance. According to this exemplary embodiment, in step 515 of outputting, the signal is output which is designed to change a trajectory and/or a speed of the vehicle. Additionally, according to this exemplary embodiment, in step 515 of outputting, the signal is output which is designed to indicate at least the pedestrian position on a display unit in the vehicle, in particular on a field of view display device.

According to this exemplary embodiment, in step 505 of reading in, the pedestrian signal is read in by the unit configured as a mobile unit, which is situated on the pedestrian. Moreover, according to this exemplary embodiment, in step 505 of reading in, the pedestrian signal is read in by the unit with the aid of radio transmission and/or radio position finding and/or a satellite positioning system. Finally, according to this exemplary embodiment, in step 505 of reading in, the pedestrian signal is read in by an integrated circuit of the mobile unit configured as a cell phone and/or a piece of clothing of the pedestrian.

According to this alternative exemplary embodiment, in step 505 of reading in, the pedestrian signal or another pedestrian signal is additionally or alternatively read in by the unit configured as an infrastructure unit.

Moreover, the method steps introduced here may be carried out repeatedly and in a different order than the one described.

If one exemplary embodiment includes an “and/or” linkage between a first feature and a second feature, this should be understood to mean that the exemplary embodiment according to one specific embodiment includes both the first feature and the second feature, and according to an additional specific embodiment includes either only the first feature or only the second feature.

What is claimed is:

1. A method for detecting at least one pedestrian by a vehicle, the method comprising:
reading in at least one pedestrian signal provided or output by a unit situated externally to the vehicle, the signal representing a pedestrian situated in a pedestrian position; and
processing the pedestrian signal to provide a signal for detecting the pedestrian.

2. The method as recited in claim 1, wherein in the step of processing, a distance between the pedestrian position and a position of the vehicle is calculated.

3. The method as recited in claim 2, further comprising:
outputting the signal when the distance drops below a minimum distance.

4. The method as recited in claim 3, wherein in the outputting step, the signal is output and is designed to change at least one of a trajectory of the vehicle and a speed of the vehicle.

5. The method as recited in claim 3, wherein in the outputting step, the signal is output and is designed to indicate at least the pedestrian position on a display unit in the vehicle on a field of view display device.

6. The method as recited in claim 1, wherein in the reading in step, the pedestrian signal is read in by the unit configured as an infrastructure unit.

7. The method as recited in claim 1, wherein in the reading in step, the pedestrian signal is read in by the unit configured as a mobile unit situated on the pedestrian.

8. The method as recited in claim 7, wherein in the reading in step, the pedestrian signal is read in by the unit with the aid of at least one of a radio transmission, radio position finding, and a satellite positioning system.

9. The method as recited in claim 8, wherein in the reading step, the pedestrian signal is read in by at least one of an integrated circuit of the mobile unit configured as a cell phone, and a piece of clothing of the pedestrian.

10. A device for detecting at least one pedestrian by a vehicle, the device configured to:
read in at least one pedestrian signal provided or output by a unit situated externally to the vehicle, the signal representing a pedestrian situated in a pedestrian position; and
process the pedestrian signal to provide a signal for detecting the pedestrian.

11. A non-transitory machine-readable storage medium on which is stored a computer program for detecting at least one pedestrian by a vehicle, the computer program, when executed by a processing unit, causing the processing unit to perform:
reading in at least one pedestrian signal provided or output by a unit situated externally to the vehicle, the signal representing a pedestrian situated in a pedestrian position; and
processing the pedestrian signal to provide a signal for detecting the pedestrian.
